(19) United States
(12) Patent Application Publication
(10) Pub. No.: US 2018/0121942 A1
(43) Pub. Date: May 3, 2018

(54) CUSTOMER SEGMENTATION VIA CONSENSUS CLUSTERING

(71) Applicant: ADOBE SYSTEMS INCORPORATED, San Jose, CA (US)

(72) Inventors: Nikolaos Vlassis, San Jose, CA (US); Hongfu Liu, Somerville, MA (US)

(21) Appl. No.: 15/342,983

(22) Filed: Nov. 3, 2016

(51) Int. Cl. G06Q 30/02

(52) U.S. Cl. CPC G06Q 30/0204

(57) ABSTRACT

The customer segmentation system includes a basic partition constructor to generate basic partitions of customers in an original feature space. Further, a partition space transformer in the customer segmentation system transforms the original feature space to an augmented partition space based on membership information of the customers into the basic partitions. Subsequently, a consensus clustering builder in the customer segmentation system determines consensus-based partitions of the customers in the augmented partition space. As such, robust and high-quality partitions for customer segmentation are achieved in the customer segmentation system.

### BACKGROUND

In general, a customer segmentation system identifies subsets of customers based on characteristics associated with customers. In this regard, customer segmentation separates customers into different groups based on characteristics associated therewith. Customers can be segmented based on any number of characteristics. For example, in some cases, subsets of customers are identified based on their demographic attributes, such as origin, gender, age, income, etc. In other cases, subsets of customers are identified based on their online interaction, such as a particular device or services being used, e.g., browser types, mobile device models, search engines, etc.; and such as where the customer navigated from, e.g., search engine, previous exit page, etc. In yet other cases, subsets of customers are identified based on other features, such as transaction histories or online profiles, e.g., social network profiles.

A customer segmentation system is useful for automatically dividing the customers into meaningful segments to perform targeted marketing, uncover unmet client needs, design new products, develop customized programs, establish proper service, allocate resources, and so on. A technique commonly used to perform customer segmentation is cluster analysis, which aims to separate data points into several groups so that the data points in the same group are more similar than those in different groups. However, the massive and high-dimensional customer data routinely brings various challenges for obtaining robust and high-quality customer segments.

### SUMMARY

Embodiments of the present invention relate to systems and methods for customer segmentation. In particular, embodiments of the present disclosure relate to a customer segmentation system based on consensus clustering technologies. As described in embodiments herein, technical solutions are provided to automatically obtain partitions for customer segmentation from high-dimensional customer data.

In various embodiments, this process for customer segmentation includes receiving a target cluster number and a group of customers in an original feature space (e.g., a customer space with various features about the customers). This process further includes generating basic partitions of the customers (i.e., clusters of customers) in the original feature space, e.g., via multiple sequential partitioning stages. The term “partition” refers to the collection of objects in a cluster. Subsequently, the original feature space is transformed into an augmented partition space, for example, based on membership information of the customers in respective basic partitions. In this augmented partition space, consensus-based partitions of the customers are determined based on the target cluster number and multiple stages of the greedy K-means based dynamic partition process.

### BRIEF DESCRIPTION OF THE DRAWINGS

Embodiments will be readily understood by the following detailed description in conjunction with the accompanying drawings.

FIG. 1 is a schematic diagram illustrating an example implementation of a customer analysis system, incorporating aspects of the present disclosure, in accordance with various embodiments.

FIG. 2 is a schematic diagram illustrating an example implementation of a customer segmentation system, incorporating aspects of the present disclosure, in accordance with various embodiments.

FIG. 3 is a schematic diagram illustrating an example implementation of a customer segmentation process, incorporating aspects of the present disclosure, in accordance with various embodiments.

FIG. 4 is a flow diagram of an example process for customer segmentation, incorporating aspects of the present disclosure, in accordance with various embodiments.

FIG. 5 is a flow diagram of an example process for generating partitions in an original space, incorporating aspects of the present disclosure, in accordance with various embodiments.

FIG. 6 is a flow diagram of an example process for generating partitions in an augmented space, incorporating aspects of the present disclosure, in accordance with various embodiments.

FIG. 7 illustrates an example computing device suitable for practicing the disclosed embodiments, in accordance with various embodiments.

### DETAILED DESCRIPTION

The massive and high-dimensional customer data today presents various technical challenges for customer segmentation. Cluster analysis is one of many techniques used for customer segmentation. Traditional approaches apply some clustering methods, such as K-means, spectral clustering, and so on, for customer segmentation. Different clustering methods have been proposed based on different assumptions. As an example, K-means is the widely used clustering method, which generally finds K centroids to represent the whole dataset. As another example, agglomerate hierarchy clustering (AHC) iteratively merges the nearest two points or clusters until all the points are in the same cluster together. As yet another example, density-based spatial clustering of applications with noise (DBSCAN) separates the points by the high-density regions.

However, because different methods provide different clustering results, it is difficult to choose the most suitable method for a specific application. For example, it is difficult to speculate the right choice for diverse customer segmentation problems, e.g., diverse customer datasets that have numerous/different factors to consider. By way of example, customer segmentation for flight passengers likely requires different factors (e.g., departure and arrival airports) compared to customer segmentation for college students in choosing their elective classes. Further, some clustering methods have many parameters to tune up, and thus become volatile when applied to diverse customer datasets.

Traditionally, consensus clustering is usually formalized into a combinational optimization problem, which sets a global objective function and adopts some heuristics to find approximate solutions. Many methods are developed to solve different objective functions, including nonnegative matrix factorization, kernel-based methods, simulated annealing, etc. There are also some methods without an explicit objective function, including graph-based algorithms, co-association matrix based methods, relabeling and voting methods, locally adaptive cluster based methods, genetic algorithm based methods, etc.

Some conventional techniques include configuring the consensus clustering problem into a K-means clustering problem via, e.g., a utility function. However, the performance of this kind of K-means clustering method is unstable due to its dependency on its initialization conditions. Further, such a method generally does not specify how to generate the basic partitions and choose the proper cluster number.

Technical solutions are disclosed here to resolve various technical issues stemming from traditional cluster analysis for customer segmentation, such as issues related to the complex data structure, the effective feature engineering, and the proper cluster number. At a high level, technical solutions are provided in a greedy K-means based consensus clustering (GKCC) system for consumer segmentation. There are two phases in the GKCC system, basic partition generation phase and consensus clustering phase. As used herein, “basic partitions” refers to partitions generated in the original feature space (e.g., a customer space with various features about the customers). As used herein, “consensus clustering” refers to generating partitions in the augmented partition space, which summarizes high-level information of customers. In some embodiments, the first phase involves generating basic partitions with the cluster number varying from 2 to 2K, where K is a user-defined cluster number, in an iterative partitioning process. In some embodiments, the second phase for the consensus clustering involves deriving a binary matrix from the basic partitions. In particular, deriving the binary matrix involves using the membership information of customers in the basic partitions. Like the process of basic partition generation, the consensus clustering phrase may also use a K-means based clustering process operated in the augmented partition space. Stated differently, K-means can be used to operate on the binary matrix to generate partitions of the customers.

The GKCC system is based on the greedy center allocation in an augmented partition space. There are many benefits of utilizing GKCC. For example, GKCC resolves the sensitivity of initialization with theoretical guarantee, incorporates the basic partition generation into a unified framework, and returns a set of partitions with different cluster numbers for practical use. GKCC conducts the cluster analysis on the augmented partition space, rather than the original feature space, which uses high-level information to capture more meaningful cluster structures and results in more robust results. By using the dynamic partition process, GKCC incrementally adds new partition centers and overcomes the sensitivity issue of K-means initialization. Further, GKCC employs a sampling strategy to search for new partition centers, e.g., with only a predetermined number of stages to generate a predetermined number of partitions. Even further, the consequent intermediate basic partitions are used later for determining the final set of basic partitions as well as the augmented partition space.

Extensive experimental results on benchmark datasets demonstrate that GKCC outperforms other state-of-the-art clustering methods in terms of objective function value and external measurements. The GKCC system outperforms traditional systems and returns the partition with small objective function value and small deviation. Advantageously, GKCC also permits the usage of user-defined or application-oriented cluster numbers so that a suitable cluster number can be chosen based on the specific customer segmentation problem. As an example, customer segmentation for worldwide Photoshop® users may requires a cluster number much greater than customer segmentation for all guests attending a state dinner in the White House.

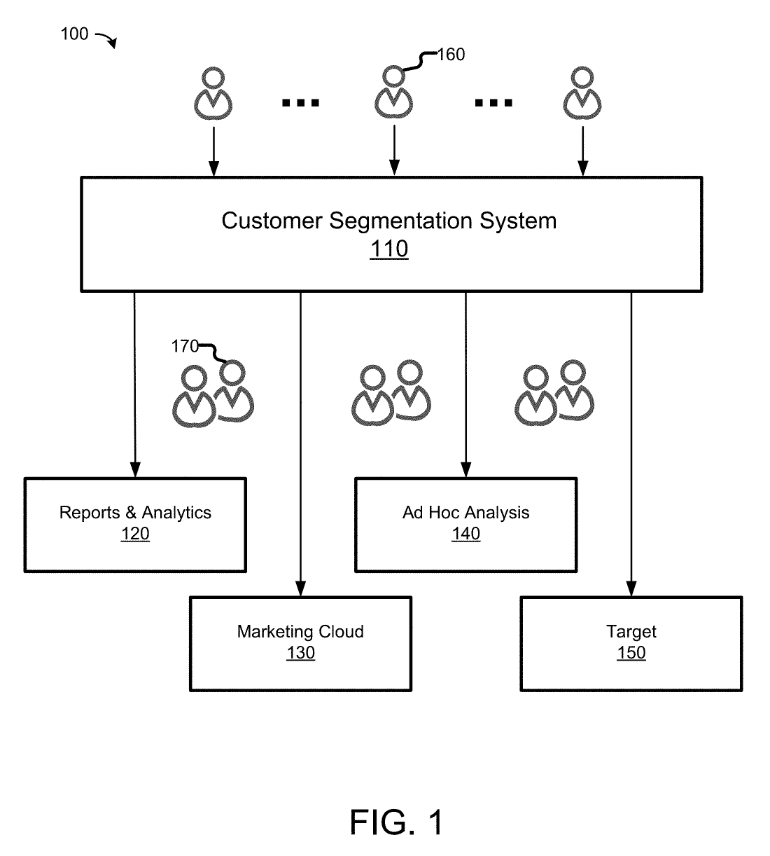

Referring now to FIG. 1, a schematic diagram illustrates an example implementation of a customer analysis system 100 in accordance with various embodiments. In the customer analysis system 100, customer segmentation can be performed for various services. To this end, the customer analysis system 100 enables the customer segmentation system 110 to support various components, such as reports and analytics 120, marketing cloud 130, ad hoc analysis 140, and target 150.

The customer analysis system 100 can include technologies that can be used to empower digital research and marketing. The customer segmentation system 110 generally identifies customer segments 170 from customers 160 based on customer information, e.g., one or more customer attributes. The one or more customer attributes selected for customer segmentation can be tailored for specific tasks, e.g., based on the needs of reports and analytics 120, marketing cloud 130, ad hoc analysis 140, and target 150. In some embodiments, real-time visitor information of customers is used for customer segmentation, which results in real-time customer segmentation information.

Reports and analytics 120 generates analytics and reports on various data, e.g., related to a specific customer segment. Standard reports may provide analytics of website and visitor activity, traffic patterns, referral data, advertising campaigns, visitor retention, product data, etc., based on customer segmentation. Reports and analytics 120 can also provide tools for users to configure segments, metrics, etc. In various embodiments, reports and analytics 120 retrieves or receives customer segmentations from the customer segmentation system 110 based on website attributes, visitor attributes, traffic attributes, referral attributes, product attributes, etc.

Reports and analytics 120 may provide summary reports for a general overview of the data. Reports and analytics 120 may also provide conversion reports related to detailed analysis of customer activity, e.g., customer conversion related to e-commerce transactions, sources of sales, advertising effectiveness, customer loyalty, and more. Even more, reports and analytics 120 may provide traffic reports related to in-depth insight into how visitors interact with a website. In various embodiments, these reports are generated based on customer segmentation information, e.g., segmented by selected customer attributes.

Marketing cloud 130 can include a set of marketing solutions to build personalized campaigns, e.g., for a targeted customer segment. A business can aim its marketing efforts and expect a reasonable return of investment from the targeted customer segment. Further, customer segmentation information can be used to design new products, determine the manufacturer's suggested retail price (MSRP) or the recommended retail price (RRP) for a new product, or estimate the success of a product or service in the marketplace.

Ad hoc analysis 140 facilitates identification of high-value customer segments with unlimited real-time visitor information, e.g., drill down into the data to get deep, precise, and comprehensive views of the customers. Ad hoc analysis 140 may also provide analysis or visualizations for customer segments over time (e.g., minutes, hours, days, weeks, etc.).

Target 150 tracks progress against target goals, e.g., based on customer segmentation. For example, target goals can be set based on customer segmentations from a geographic region or customer segmentations associated with specific transactions. Target 150 can also be used to measure performance of a website. When a target is created, one or more specific attribute metrics are measured, or an entire website is measured against some selected metrics. As an example, one can measure the number of visitors to a website (i.e., customer segment to the website) and use it as a target. Meanwhile, the customer segment from a specific source (e.g., geographical region, demographic characteristic) can also be used if the target is further drilled down to the number of visitors to the website from the specific source.

Although FIG. 1 provides various services that may utilize customer segmentation, as can be appreciated, any number or types of services might utilize customer segmentation to obtain or provide information.

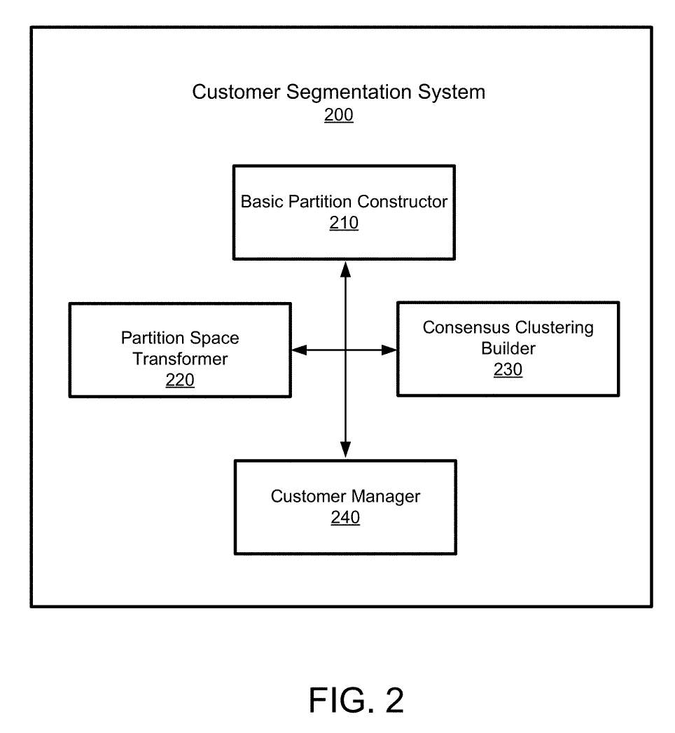

FIG. 2 is a schematic diagram illustrating an example implementation of a customer segmentation system 200. In various embodiments, customer segmentation system 200 includes basic partition constructor 210, partition space transformer 220, consensus clustering builder 230, and customer manager 240 operatively coupled with each other. In some embodiments, customer segmentation system 200 is a server computing device and/or service, such as a server and/or a service provided in a computing cloud, and interacts with other servers or user computing devices. In alternative embodiments, customer segmentation system 200 can be integrated with another server or user computing device.

Customer segmentation system 200 uses GKCC for customer segmentation. As described herein, GKCC is based on greedy center allocation in an augmented partition space built from basic partitions generated in the original feature space. To generate the basic partitions, a greedy dynamic search process can be used to incrementally choose new partition centers, which mitigates the sensitivity issue (e.g., not able to select reasonable initial partition centers) related to the initialization stage of K-means clustering methods. A predetermined number (e.g., 59) is used in the sampling strategy to accelerate the greedy dynamic search process. Advantageously, customer segmentation system 200 overcomes the sensitivity issue of traditional K-means clustering and returns partitions with small objective function value and small deviation.

Customer segmentation system 200 utilizes basic partition constructor 210 to receive customer data with various customer attributes and to determine basic partitions of the customers in the original feature space.

The term “feature space” refers to an n-dimensional space for hosting numerical features that represent objects. As an example, an object is represented by an n-dimensional vector in the feature space. The term “original feature space” refers to the feature space associated with the original features extracted from the raw data of the objects, e.g., raw customer information. By way of example, customers may have various attributes, such as attributes of demographics, attributes of computing devices, attributes of online activities, etc. One or more of such customer attributes may be used as the original features for representing the customers and constructing the original feature space.

In various embodiments, the basic partitions are incrementally generated in multiple stages of partitioning in a dynamic partition process. An object in the feature space may be also referred as a point in the feature space. In one embodiment, 59 points from the original feature space are randomly selected as the candidates. The point with the minimum objective function value is further selected and added to the set of existing cluster centers for computing the new cluster centers.

In some embodiments, the basic partitions are generated with the cluster number varying from 2 to 2K, where K is a user-defined cluster number, e.g., defined based on the specific needs of reports and analytics 120, marketing cloud 130, ad hoc analysis 140, and target 150 in the customer analysis system 100. For a certain stage k in the GKCC process, one random selected point for K-means clustering is added to the cluster centers from the previous stage to determine a set of partitions and the object function value associated with the set of partitions. For the certain stage k, such process is repeated for a predetermined number of times (e.g., 59 times), which results in different sets of partitions (e.g., 59 sets) for later fusion and respective objective function values associated with those randomly selected points. The point associated with the minimum objective function value is added to the existing centers to further compute the partitions and return a new set of centers for the next stage.

The partition space transformer 220 is to transform the original feature space to an augmented partition space based on membership information of the customers in the basic partitions, e.g., including the final set of basic partitions and the intermediate basic partitions. The phrase “augmented partition space” refers to the augmented feature space, which summarizes high-level information compared with the original feature space. By way of example, membership information of the customers in basic partitions in the original feature space may be used to construct the augmented partition space. “Membership information” refers to whether a customer belongs to a basic partition. In some embodiments, membership information is represented by a binary value to indicate the customer either in or not in a partition. In some embodiments, membership information is represented by a probability to indicate the likelihood of the customer in the partition.

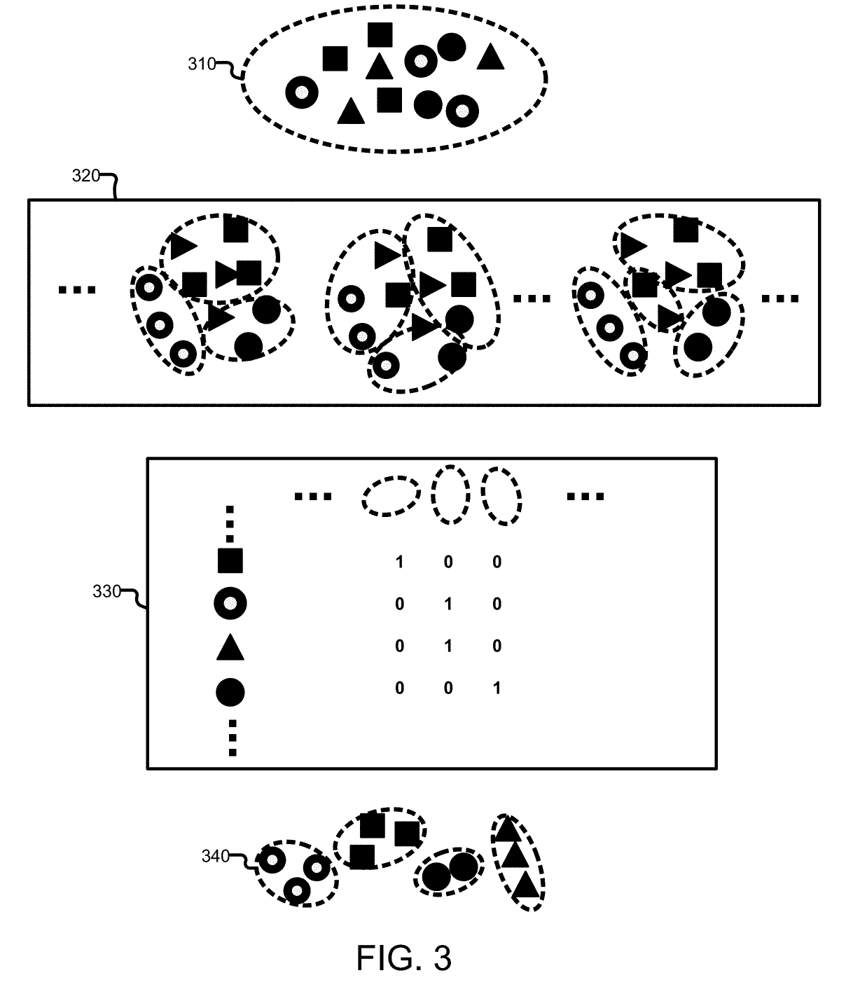

In some embodiments, partition space transformer 220 is to construct a data structure to represent the augmented partition space with elements in the data structure corresponding to membership information of the customers in the basic partitions, e.g., as shown in augmented partition space 330 in FIG. 3, where the membership information is represented in a binary matrix. In some embodiments, the membership information of customers in the basic partitions are used to build the binary matrix. The membership information of customers in the basic partitions may be concatenated sequentially based on the order these basic partitions are generated. Alternatively, the memberships information of customers in the basic partitions may be randomly concatenated without any specific pre-determined order. In other embodiments, only selective membership information of customers in the basic partitions are used to construct the augmented partition space, e.g., only basic partitions generated in the odd or even number of partitioning stages are used in one embodiment.

The consensus clustering builder 230 generally determines consensus-based partitions of the customers in the augmented partition space (e.g., represented by the concatenated binary matrix). In one implementation, consensus-based partitions can be determined based on multiple stages of partitioning process operated in the augmented partition space. In various embodiments, after a binary matrix being derived from the basic partitions, K-means based clustering is conducted on the binary matrix. This dynamic partition process starts with two centers (i.e., from k=2). One can be the center of the binary matrix, and the other can be a randomly selected point in the binary matrix. For k=2, the dynamic partition process generates two partitions as well as an objective function value for the randomly selected point.

This dynamic partition process is repeated several times, e.g., with another randomly selected point to replace the previously randomly selected point. Subsequently, the randomly selected point with the minimum objective function value is selected to determine the partitions and the corresponding centers for the next stage of processing. Eventually, consensus clustering builder 230 stops when the consensus clustering process yields the predetermined cluster number K.

The customer manager 240 is to manage customers and customer attributes. In various embodiments, customer manager 240 provides different interfaces to other components in the customer analysis system 100 of FIG. 1, such as reports and analytics 120, marketing cloud 130, ad hoc analysis 140, and target 150, so that customer data can be selected and fed to the basic partition constructor 210 based on specific purposes of those related components in the customer analysis system 100. Further, customer manager 240 can also manage the results of customer segmentation, e.g., customer partitions associated with a specific report. In various embodiments, customer manager 240 provides the customer segmentation information to reports and analytics 120, marketing cloud 130, ad hoc analysis 140, and target 150 in response to their respective needs.

In other embodiments, customer segmentation system 200 can be implemented differently than what is depicted in FIG. 2. As an example, partition space transformer 220 can be combined with consensus clustering builder 230 to form a comprehensive consensus clustering component to manage customer segmentation in the augmented partition space. In some embodiments, components depicted in FIG. 2 have a direct or indirect connection not shown in FIG. 2. In some embodiments, some of the components depicted in FIG. 2 are divided into multiple components. As an example, basic partition constructor 210 can be divided into separate components, e.g., one component responsible for generating objective function values for customers and another component responsible for generating basic partitions. Further, one or more components of customer segmentation system 200 can be located across any number of different devices and/or networks. As an example, customer manager 240 can be implemented as an independent server or an independent component in a data server.

In some embodiments, customer segmentation system 200 is embodied as a specialized computing device. In some embodiments, customer segmentation system 200 can be embodied, for example, as an application or a mobile app. In some embodiments, customer segmentation system 200 can be a distributed system; for example, basic partition constructor 210, partition space transformer 220, consensus clustering builder 230, and customer manager 240 can be distributed across any number of servers. Regardless of the computing platform on which customer segmentation system 200 is implemented, customer segmentation system 200 can be embodied as a hardware component, a software component, or any combination thereof for managing customer segmentation.

FIG. 3 is a schematic diagram illustrating an example implementation of a customer segmentation process in accordance with various embodiments. The original feature space 310 includes many customers represented by their respective customer attributes. The basic partition constructor 210 in FIG. 2 identifies the basic partition 320 from the original feature space 310 through a dynamic partition process. In each stage of the dynamic partition process, the objective function value of different sets of partitions are measured, the set of partitions with the minimum objective function value is adopted to advance the process to the next stage.

The augmented partition space 330, in this embodiment, is constructed by concatenating the membership information of all basic partitions in a binary matrix, where the positive membership is represented as 1 and the negative membership is represented as 0. Subsequently, consensus-based clusters 340 are determined in this augmented partition space. GKCC uses high-level information to capture more meaningful cluster structures as GKCC conducts the cluster analysis on the augmented partition space 330, rather than the original feature space 310. Meanwhile, GKCC overcomes the sensitivity of K-means initialization based on its greedy dynamic search and incrementally adding new centers. Further, a fixed numbers of sampling (e.g., 59) is adopted in this GKCC process for acceleration and efficiency.

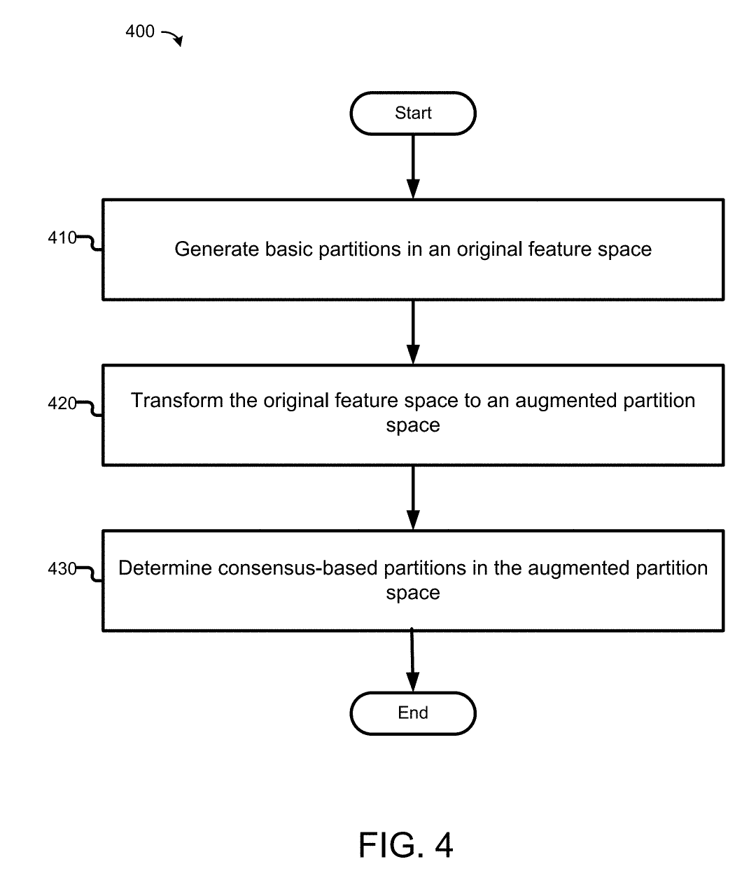

FIG. 4 is a diagram of an example process 400 for customer segmentation, in accordance with various embodiments of the present disclosure. Process 400 can be performed, for example, by customer segmentation system 200. Process 400 can be performed by processing logic that comprises hardware (e.g., circuitry, dedicated logic, programmable logic, microcode, etc.), software (e.g., instructions run on a processing device to perform hardware simulation), or a combination thereof. The processing logic can be configured to manage customer segmentation.

In various embodiments, the process begins at block 410, where basic partitions are generated in the original feature space, e.g., by basic partition constructor 210 of FIG. 2. In various embodiments, these basic partitions are generated in a dynamic partitioning process with sequential partitioning stages. The basic partitions generated in a certain partitioning stage is based on the information from the previous partitioning stage. Basic partitions are incrementally generated through these sequential partitioning stages. This means different partitioning stages generate different number of partitions in some embodiments. In one embodiment, a later partitioning stage generates at least one more partition than an earlier partitioning stage, such as shown in the Example GKCC-59 below.

At block 420, the original feature space is transformed into an augmented partition space, e.g., by partition space transformer 220 of FIG. 2. Next, at block 430, consensus-based partitions in the augmented partition space are determined, e.g., by consensus clustering builder 230 of FIG. 2.

To further illustrate the example process 400 for customer segmentation, a particular embodiment, GKCC-59, is listed herein, with training data X, the cluster number K, and the predetermined sampling number 59 as the input to the GKCC. Let X={x₁, x₂, . . . , xₙ} be a set of n data points belonging to K clusters, denoted as C={C₁, . . . , Cₖ} where Cₖ∩C_{k′}=Ø, ∀k≠k′, and ∪ₖ₌₁^{K}Cₖ=X. Given r basic partitions represented as π={π₁, π₂, . . . , πᵣ}, each of which partitions X into Kᵢ clusters, and maps each data point to a cluster label ranged from 1 to Kᵢ.

### Example: GKCC-59

Let π=Ø be the set of basic partitions;
Let C=Ø be the set of centers;
C=C∪ the center of X;
Set k=2;
while k≤2K do
Step 1. Sampling 59 points from X, dᵢ with 1≤i≤59

Step 2. Generate basic partitions and update centers.
for i=1, . . . , 59 do
   C′=C∪ dᵢ;
   Run K-means on X with the initial center C′ and return the partition π′ and the objective function value objCᵢ;

π=π∪π′

end

Run K-means on X with the initial center C∪d_{argmin}_{ᵢ}_{objC}_{ᵢ}, and return the new centers as C.

Step 3. k=k+1.

end

Build the binary matrix B by Eq. 3;

Let B=Ø be the set of centers;

B=B∪ the center of B;

Set k=2;

while k≤K do

Step 1. Sampling 59 points from B, bᵢ with 1≤i≤59.

Step 2. Generate consensus clustering and update centers.
for i=1, . . . , 59 do
   B′=B∪bᵢ;
   Run K-means on B with the initial center B′ and return the objective function value objBᵢ;

end

Run K-means on B with the initial center

$$B ⋃ {b}_{{argmin}_{{ }_{i} obj} {B}_{i}}$$

and return the partition as πᵢ and the new centers as B.

Step 3. k=k+1.

End

Output: π and πᵢ with 1≤i≤K.

The goal of consensus clustering is to find an optimal consensus partition π, in other words, to find the consensus partition sharing the maximum utility function value with basic partitions as shown in Eq. 1, where U is a utility function that measures the similarity between two partitions of (π, πᵢ). In this way, the utility function (U) is used to measure the relationship (e.g., similarity) between one set of partitions (e.g., π) and another set of partitions (e.g., πᵢ). In some embodiments, the Categorical Utility Function (CUF) in Eq. 2 is used as the utility function (U). In Eq. 2, pₖⱼ⁽ⁱ⁾ is the joint probability of one instance simultaneously belonging to Cₖ and Cⱼⁱ. Here, Cₖ is the k-th cluster in final partition π, and Cⱼⁱ is the j-th cluster in πᵢ. pₖ₊ and p₊ⱼ are the cluster portion of π and πᵢ, respectively.

$$\begin{matrix}{max}_{π} {\sum }_{i = 1}^{r} U ( π , {π}_{i} ) & Eq . 1 \\ {U}_{c} ( π , {π}_{i} ) {\sum }_{k = 1}^{K} {p}_{k} + {\sum }_{j = 1}^{{K}_{i}} {( \frac{{p}_{kj}^{( i )}}{{p}_{k +}} )}^{2} - {\sum }_{j = 1}^{{K}_{i}} {( {p}_{+ j}^{( i )} )}^{2} & Eq . 2 \\ b ( x ) = 〈 {b ( x )}_{1} , … , {b ( x )}_{r} 〉 , \\ {b ( x )}_{i} = 〈 {b ( x )}_{i 1} , … , {b ( x )}_{{iK}_{i}} 〉 , \\ {b ( x )}_{ij} = \{ \begin{matrix}1 , & if {π}_{i} ( x ) = j \\ 0 , & otherwise\end{matrix} . & Eq . 3\end{matrix}$$

The complex consensus clustering problem with CUF can be mapped into a K-means clustering problem with a binary matrix. Let B={b(x)} be a binary dataset derived from the set of r basic partitions II as shown in Eq. 3. In some embodiments, B is the concatenated matrix of all the basic partitions in 1-of-Kᵢ coding, where Kᵢ is the cluster number of πᵢ. The final consensus clustering is obtained by running K-means on B with squared Euclidean distance in one embodiment.

This embodiment, GKCC-59, handles three challenges together, namely how to generate basic partitions, set the proper cluster number, and handle the initialization sensitivity of K-means. At block 410, the basic partitions are generated from the original feature space. At block 430, the consensus clusters are generated from the augmented partition space. In one embodiment, in the first loop for generating the basic partitions, the cluster number is conditioned to be 2K, while in the second loop, the cluster number for consensus clustering is conditioned to be K. Therefore, the number of stages for generating the basic partitions in the original feature space is greater than the number of stages for obtaining the consensus-based final partitions in the augmented partition space.

In the example of GKCC-59, the process starts with one center, i.e., the center of the data X, and incrementally adds new centers by randomly selecting 59 points as the candidates and picking up a candidate for the next stage of partitioning per the objective function value of K-means. During this process, 59 clustering results are obtained for a certain cluster number, which are used as basic partitions for further consensus clustering. After obtaining the set of basic partitions π, the greedy strategy is still applied for the consensus partition. Further, sampling is limited to 59 points to accelerate the search process. In other embodiments, the predetermined number for sampling can be in a range of 40 to 80, or other suitable sampling numbers based on specific applications.

During the basic partition generation, the cluster number is varied from 2 to 2K to increase the diversity of the basic partitions. Moreover, for a certain cluster number k, the (k−1) centers from the previous stage and one additional randomly selected point are used for K-means clustering. As a result, a large number of basic partitions can be obtained to construct the augmented partition space in the GKCC process.

Here, 59 points are sampled to choose the optimal point to be used to obtain the new cluster centers for the next stage. By dynamically adding new centers, GKCC mitigates the sensitivity issue of K-means because the partition centers do not need to be selected at the same time. Further, the number of samples is limited to the predetermined number of 59 here to avoid the brute-force global search for an optimal new center. Even further, all resulting 59 partitions in each stage can be used to construct the augmented partition space. In this embodiment, there are 59*(2K−1) basic partitions, which is likely large enough to construct a feature-rich augmented partition space.

GKCC is suitable for large-scale clustering as its time complexity is linear to the number of customers. The time complexity for generating basic partitions is O(InK²m), where I is the average stage number, n is the number of points (i.e., customers), K is the cluster number and m is the number of features. The time complexity for consensus clustering is O(InK³). Since K<<n and m<<n, the overall time complexity of GKCC is linear to n. Therefore, GKCC is suitable for large-scale clustering. Further, GKCC generally returns the stable partitions with a small variance.

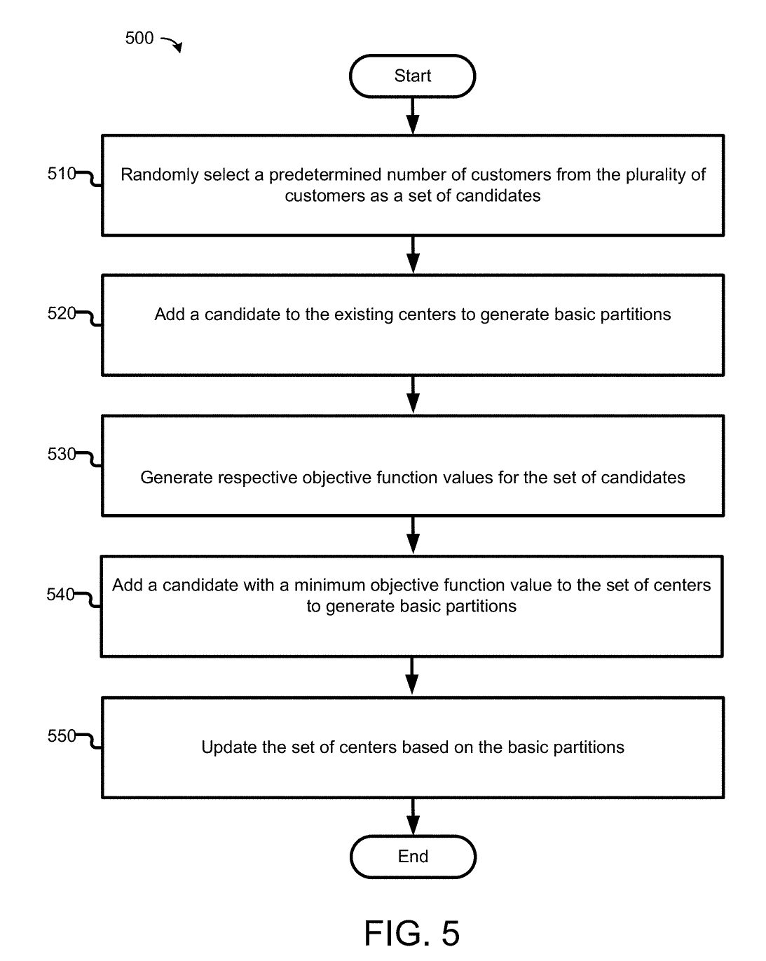

Referring now to FIG. 5, a flow diagram of an example process 500 for generating partitions in an original space, which is to be practiced by an example customer segmentation system, in accordance with various embodiments, is provided. As shown, process 500 is to be performed by customer segmentation system 200 of FIG. 2 to implement one or more embodiments of the present disclosure. Like process 400, in various embodiments, process 500 may have fewer or additional operations, or perform some of the operations in different orders.

At block 510, a predetermined number of customers are randomly selected from a group of customers as a set of candidates for the present stage, e.g., enabled by basic partition constructor 210 of FIG. 2. In various embodiments, the predetermined number is selected from a range of 40-80 to ensure there are sufficient samples to yield a cluster center for the next stage in the GKCC process. Meanwhile, this sampling strategy is also adopted to avoid exhaustive search in the original feature space for an optimal cluster center.

At block 520, for each candidate of the set of candidates, the candidate is added to the existing centers to generate a set of basic partitions of the customers in the original feature space, e.g., based on the K-means clustering. As a result, each candidate will have a corresponding set of basic partitions.

At block 530, respective objective function values for the set of candidates are determined based on, e.g., the standard K-means objective function value associated with a set of basic partitions. In some embodiments, the objective function value indicates a distance measure of the customers from their respective partition centers, e.g., based on a squared error function. Subsequently, the objective function value associated with the candidate can be determined based on the distance measure.

At block 540, the candidate with a minimum objective function value is added to the set of partition centers determined at a prior stage, and basic partitions for the present stage are generated based on the current set of partition centers, e.g., after running a K-means clustering process. At block 550, the new set of centers are returned. Subsequently, the process is moving to the next stage or iteration.

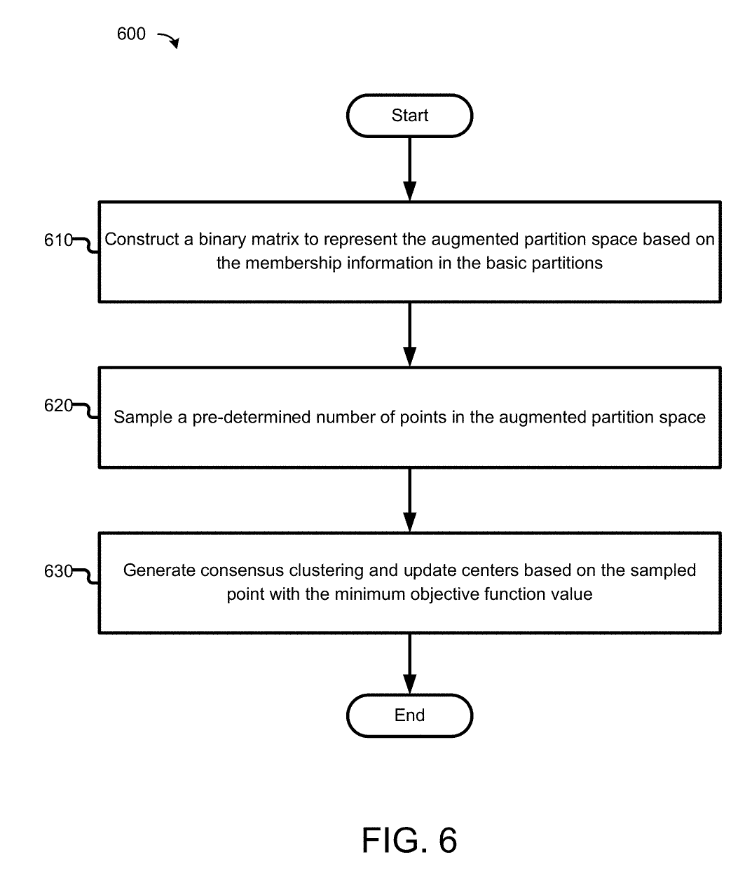

FIG. 6 is a flow diagram of an example process 600 for generating partitions in an augmented space, which is to be practiced by an example customer segmentation system in accordance with various embodiments. As shown, process 600 is to be performed by, e.g., consensus clustering builder 230 of FIG. 2 to implement one or more embodiments of the present disclosure. Similar to process 500, in various embodiments, process 600 may have fewer or additional operations, or perform some of the operations in different orders.

At block 610, a binary matrix is constructed to represent the augmented partition space based on the membership information in the basic partitions, e.g., enabled by consensus clustering builder 230 of FIG. 2. By way of example, the binary matrix can be constructed based on Eq. 3. In some embodiments, the binary matrix includes the membership information from all basic partitions identified in the original feature space, e.g., including the final set of basic partitions and all intermediate basic partitions generated in the dynamic partition process. In some embodiments, selected basic partitions, e.g., all basic partitions related to an even or odd number of cluster centers, such as when the center number k is even or odd in the example of GKCC-59, are used for constructing the binary matrix. In some embodiments, a few basic partitions are randomly selected to construct the binary matrix.

At block 620, the process samples a predetermined number of points in the augmented partition space, e.g., enabled by consensus clustering builder 230 of FIG. 2. In one embodiment, the predetermined number of points is 59 points, as illustrated in the example of GKCC-59. In other embodiments, a different sampling number may be used.

At block 630, consensus clustering is performed, e.g., based on K-means on the binary matrix, e.g., enabled by consensus clustering builder 230 of FIG. 2. Further, cluster centers are updated, e.g., the sampled point with the minimum objective function value is added to the previous centers to further compute the corresponding center for the next stage in the GKCC process.

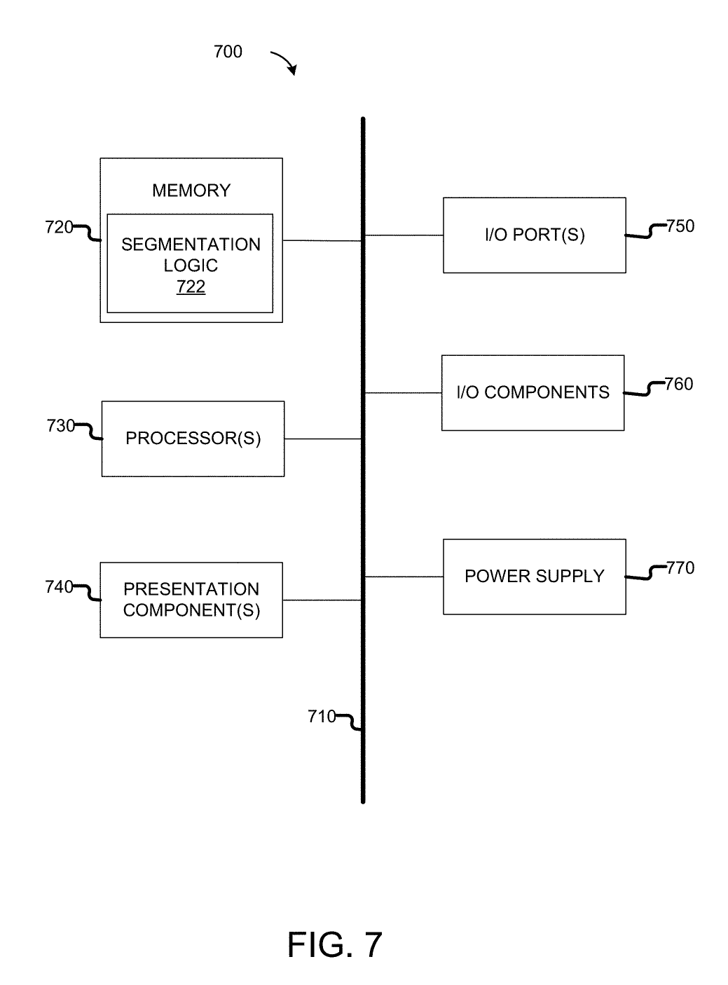

Having briefly described an overview of embodiments of the present invention, an exemplary operating environment in which embodiments of the present invention is to be implemented is described below to provide a general context for various aspects of the present invention. Referring initially to FIG. 7, an exemplary operating environment for implementing embodiments of the present invention is shown and designated generally as computing device 700. Computing device 700 is but one example of a suitable computing environment and is not intended to suggest any limitation as to the scope of use or functionality of the invention. Neither should the computing device 700 be interpreted as having any dependency or requirement relating to any one or combination of components illustrated.

The disclosure is described in the general context of computer code or machine-useable instructions, including computer-executable instructions such as program modules, being executed by a computer or other machines, such as a smartphone or other handheld devices. Generally, program modules, including routines, programs, objects, components, data structures, etc., refer to code that perform particular tasks or implement particular abstract data types. The embodiments of this disclosure are to be practiced in a variety of system configurations, including handheld devices, consumer electronics, general-purpose computers, more specialty computing devices, etc. The embodiments of this disclosure are also to be practiced in distributed computing environments where tasks are performed by remote-processing devices that are linked through a communications network.

Regarding FIG. 7, computing device 700 includes a bus 710 that directly or indirectly couples the following devices: memory 720, one or more processors 730, one or more presentation components 740, input/output (I/O) ports 750, input/output (I/O) components 760, and an illustrative power supply 770. Bus 710 represents one or more busses (such as an address bus, data bus, or a combination thereof). Although the various blocks of FIG. 7 are shown with lines for the sake of clarity, in reality, delineating various components is not so clear, and metaphorically, the lines would more accurately be fuzzy. For example, a presentation component such as a display device could also be considered as an I/O component. Also, processors have memory. The inventor recognizes that such is the nature of the art, and reiterates that the diagram of FIG. 7 is merely illustrative of an exemplary computing device that is used in connection with one or more embodiments of the present invention. Distinction is not made between such categories as “workstation,” “server,” “laptop,” “handheld device,” “smartphone,” etc., as all are contemplated within the scope of FIG. 7 and reference to “computing device.”

Computing device 700 typically includes a variety of computer-readable media. Computer-readable media includes any available media to be accessed by computing device 700, and includes both volatile and nonvolatile media, and removable and non-removable media. By way of example, and not limitation, computer-readable media comprises computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which is used to store the desired information and which is accessed by computing device 700. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 720 includes computer storage media in the form of volatile and/or nonvolatile memory. In various embodiments, the memory is removable, non-removable, or a combination thereof. Exemplary hardware devices include solid-state memory, hard drives, optical-disc drives, etc. Computing device 700 includes one or more processors 730 that read data from various entities such as memory 720 or I/O components 760. Presentation component(s) 740 present data indications to a user or a device. Exemplary presentation components include a display device, speaker, printing component, vibrating component, etc.

In various embodiments, memory 720 includes, in particular, temporal and persistent copies of segmentation logic 722. Segmentation logic 722 includes instructions that, when executed by one or more processors 730, result in computing device 700 managing customer segmentation, such as, but not limited to, process 300, process 400, process 500, or process 600. In various embodiments, segmentation logic 722 includes instructions that, when executed by processors 730, result in computing device 700 performing various functions associated with, but not limited to, basic partition constructor 210, partition space transformer 220, consensus clustering builder 230, or customer manager 240, in connection with FIG. 2.

In some embodiments, one or more processors 730 are to be packaged together with segmentation logic 722. In some embodiments, one or more processors 730 are to be packaged together with segmentation logic 722 to form a System in Package (SiP). In some embodiments, one or more processors 730 are integrated on the same die with segmentation logic 722. In some embodiments, processors 730 are integrated on the same die with segmentation logic 722 to form a System on Chip (SoC).

I/O ports 750 allow computing device 700 to be logically coupled to other devices including I/O components 760, some of which are built-in components. Illustrative components include a microphone, joystick, game pad, satellite dish, scanner, printer, wireless device, etc. In some embodiments, the I/O components 760 also provide a natural user interface (NUI) that processes air gestures, voice, or other physiological inputs generated by a user. In some embodiments, inputs are to be transmitted to an appropriate network element for further processing. Additionally, the computing device 700 is equipped with sensors (e.g., accelerometers or gyroscopes) that enable detection of motion. The output of the sensors is to be provided to the display of the computing device 700 to render immersive augmented reality or virtual reality.

Although certain embodiments have been illustrated and described herein for purposes of description, a wide variety of alternate and/or equivalent embodiments or implementations calculated to achieve the same purposes could be substituted for the embodiments shown and described without departing from the scope of the present disclosure. This application is intended to cover any adaptations or variations of the embodiments discussed herein. Therefore, it is manifestly intended that embodiments described herein be limited only by the claims.

An abstract is provided herein to facilitate the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. One or more non-transient computer storage media comprising computer-implemented instructions that, when used by one or more computing devices, cause the one or more computing devices to:
receive information of a plurality of customers associated with an original feature space;
generate a first plurality of partitions of the plurality of customers based on a first plurality of sequential partitioning stages operated using the original feature space, wherein a first partitioning stage generates more partitions than a second partitioning stage in the first plurality of sequential partitioning stages;
build an augmented partition space based on membership information of the plurality of customers in the first plurality of partitions; and
determine a second plurality of partitions of the plurality of customers based on a second plurality of sequential partitioning stages operated using the augmented partition space.

2. The one or more computer storage media of claim 1, the instructions further cause the one or more computing devices to:
randomly select, from the plurality of customers, a first predetermined number of customers as a set of candidates for a present stage of the first plurality of partitioning stages;
generate a second predetermined number of partitions of the plurality of customers in the original feature space for each candidate of the set of candidates; and
determine an objective function value associated with each candidate in the present stage.

3. The one or more computer storage media of claim 2, wherein the first predetermined number is in a range of 40 to 80.

4. The one or more computer storage media of claim 2, wherein the objective function value indicates a distance measure of the plurality of customers from a respective partition center.

5. The one or more computer storage media of claim 2, the instructions further cause the one or more computing devices to:
add, to a set of partition centers, a candidate having a minimum objective function value in the present stage;
generate partitions of the plurality of customers for the present stage based on the set of partition centers; and
update the set of partition centers based on the partitions of the plurality of customers for the present stage.

6. The one or more computer storage media of claim 1, the instructions further cause the one or more computing devices to:
construct a binary matrix to represent the augmented partition space with binary elements in the binary matrix corresponding to the membership information of the plurality of customers in the first plurality of partitions.

7. The one or more computer storage media of claim 1, the instructions further cause the one or more computing devices to:
concatenate the membership information of the plurality of customers in the first plurality of partitions;
construct a binary matrix to represent the augmented partition space with binary elements in the binary matrix corresponding to the concatenated membership information.

8. The one or more computer storage media of claim 1, wherein the first plurality of sequential partitioning stages has more stages than the second plurality of sequential partitioning stages.

9. The one or more computer storage media of claim 1, the instructions further cause the one or more computing devices to:
generate the first plurality of partitions of the plurality of customers in the original feature space based on a greedy K-means clustering method.

10. A computer-implemented method, comprising:
receiving information of a plurality of customers associated with an original feature space and a cluster number;
generating a first plurality of partitions of the plurality of customers through a first plurality of sequential partitioning stages operated in the original feature space;
transforming the original feature space to an augmented partition space based on membership information of the plurality of customers in the first plurality of partitions; and
determining a second plurality of partitions of the plurality of customers in the augmented partition space based on the cluster number and a second plurality of sequential partitioning stages operated using the augmented partition space.

11. The method of claim 10, further comprising:
randomly selecting a predetermined number of customers from the plurality of customers as a set of candidates for a present stage of the first plurality of sequential partitioning stages; and
generating respective partitions of the plurality of customers in the original feature space for each candidate of the set of candidates.

12. The method of claim 11, further comprising:
measuring distances from the plurality of customers to their respective partition centers associated with a candidate; and
determining an objective function value associated with the candidate based on the measured distances.

13. The method of claim 12, further comprising:
adding a candidate having a minimum objective function value in the present stage to a set of partition centers determined at a prior stage;
generating partitions for the present stage based on the set of partition centers; and
updating the set of partition centers based on the partitions for the present stage.

14. The method of claim 10, further comprising:
constructing a data structure to represent the augmented partition space with elements in the data structure corresponding to membership information of the plurality of customers in the first plurality of partitions.

15. The method of claim 10, wherein the first plurality of sequential partitioning stages has more stages than the second plurality of sequential partitioning stages.

16. A system, comprising:
means for generating a first plurality of partitions of a plurality of customers in a first plurality of sequential partitioning stages operated using an original feature space;
means for transforming the original feature space into an augmented partition space based on membership information of the plurality of customers in the first plurality of partitions; and
means for determining a second plurality of partitions of the plurality of customers in a second plurality of partitioning stages operated using the augmented partition space.

17. The system of claim 16, the system further comprising:
means for randomly selecting a predetermined number of customers from the plurality of customers as a set of candidates for a present stage of the first plurality of partitioning stages;
means for generating respective partitions for the plurality of customers in the original feature space for each candidate of the set of candidates; and
means for determining an objective function value associated with each candidate in the present stage based on respective partitions associated with each candidate.

18. The system of claim 17, the system further comprising:
means for adding a candidate having a minimum objective function value in the present stage to a set of partition centers generated from a prior stage of the first plurality of partitioning stages;
means for generating partitions for the present stage based on the set of partition centers; and
means for updating the set of partition centers based on the partitions for the present stage.

19. The system of claim 16, wherein the original feature space comprises indications of customer features related to visitor activity information, traffic pattern information, referral data information, advertising campaign information, visitor retention information, or product data information.

20. The system of claim 16, wherein the augmented partition space comprises a binary matrix with binary elements representing the membership information of the plurality of customers in the first plurality of partitions.
